(19) United States
(12) Patent Application Publication
(10) Pub. No.: US 2001/0047909 A1
(43) Pub. Date: Dec. 6, 2001

(54) SUPPORT FOR LIFT DOOR DRIVE

(76) Inventors: FRANK MOLLENAUER, BERLIN (DE); BODO GRAEBNER, INWIL (CH)

Correspondence Address: KLAUS P STOFFEL, COHEN PONTANI LIEBERMAN & PAVANE, 551 FIFTH AVENUE, SUITE 1210, NEW YORK, NY, 10176

(21) Appl. No.: 09/230,990

(22) PCT Filed: Aug. 4, 1997
(86) PCT No.: PCT/CH97/00291

§ 371 Date: None

(30) Foreign Application Priority Data
Aug. 13, 1996 (EP) 96810537.9

(51) Int. Cl. B66B 13/02; B66B 11/02

(52) U.S. Cl. 187/324; 187/315; 187/318

(57) ABSTRACT

These carriers for the reception of all important components of a door drive can be used in different door systems with different entrance widths. For this purpose the carrier (10) consists of a base part (11) and a length adapter (12), which are connectible together in such a manner that carriers (10) of different lengths can be produced.

The invention relates to a carrier for door drives of lifts. Carriers of that kind, which are mounted on the roof of a lift cage at the door side, serve for the reception of all important components for the door drive, such as, for example, translation gear, belt drive, motor bearer with drive motor, guide rails, etc. In general, in the case of door drives for lifts such as have become known by, for example, U.S. Pat. No. 4,149,615 or European patent specification 0 513 509, the carriers are conceived on each occasion only for a specific door system. In the case of different door systems with different entrance widths, carriers of different lengths matched to the entrance widths are required for the aforesaid door drives, whereby warehousing is more costly and the door drives are more expensive.

The invention is based on the task of proposing a carrier of the kind stated in the introduction, which does not have the above-mentioned disadvantages.

This task is solved by the invention indicated in patent claim 1. In that case the carrier consists of a base part and a length adapter, which are connectible together in such a manner that carriers of different lengths can be produced.

The advantages achieved by the invention are to be seen in that one and the same carrier can be used for different door systems with different entrance widths (for example, 600 to 800 millimetres). With the carrier the drive components can be arranged in such a manner that it is possible to reach all important components from the storey. The carrier according to the invention has a geometric form which offers mechanical protection for the belt drive unit, whereby, in particular, a protection against objects, dirt, water, etc., falling down as well as against wanton destruction by lift users is guaranteed. The carrier is adjustable not only horizontally, but also vertically, so that an adaptation to different cages and compensation for tolerances are possible. Costs can be saved by this carrier and warehousing simplified.

The invention is more closely explained in the following by reference to an example of embodiment in conjunction with the drawings, in which:

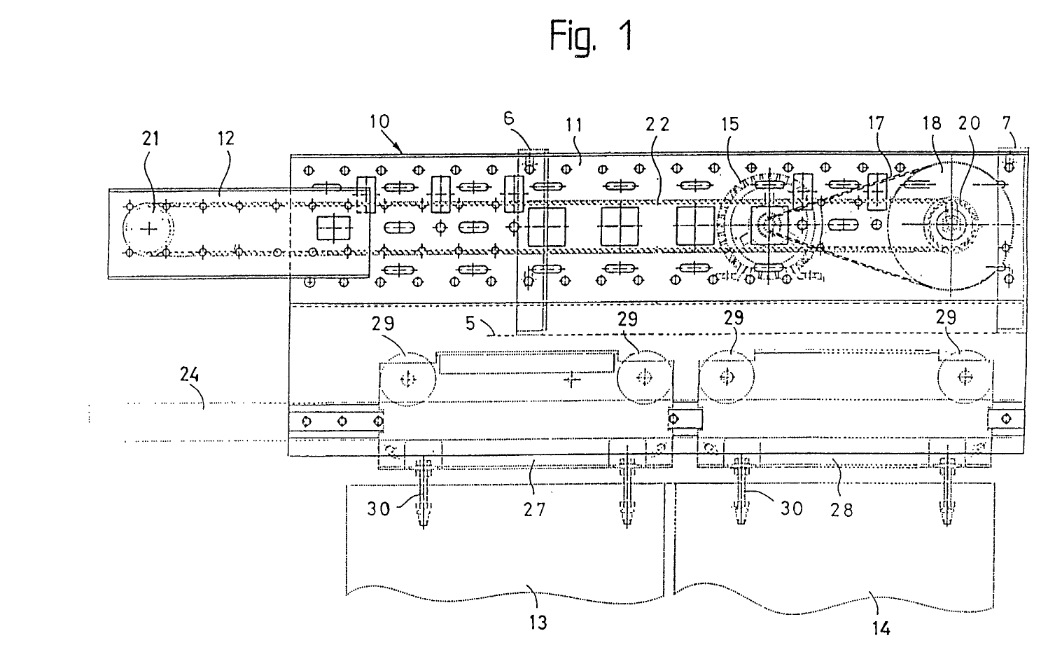

FIG. 1 shows an elevation of the carrier according to the invention, with mounted door drive components;

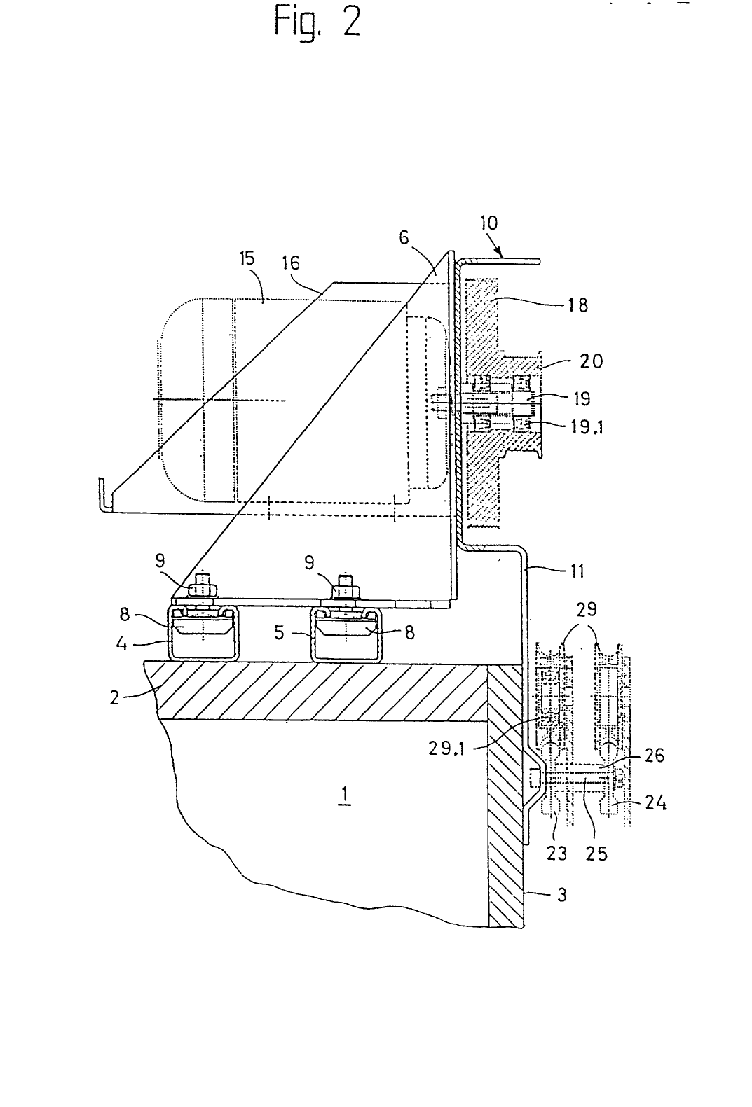

FIG. 2 shows a partially sectioned side elevation of the carrier with door drive components, in a scale enlarged relative to FIG. 1;

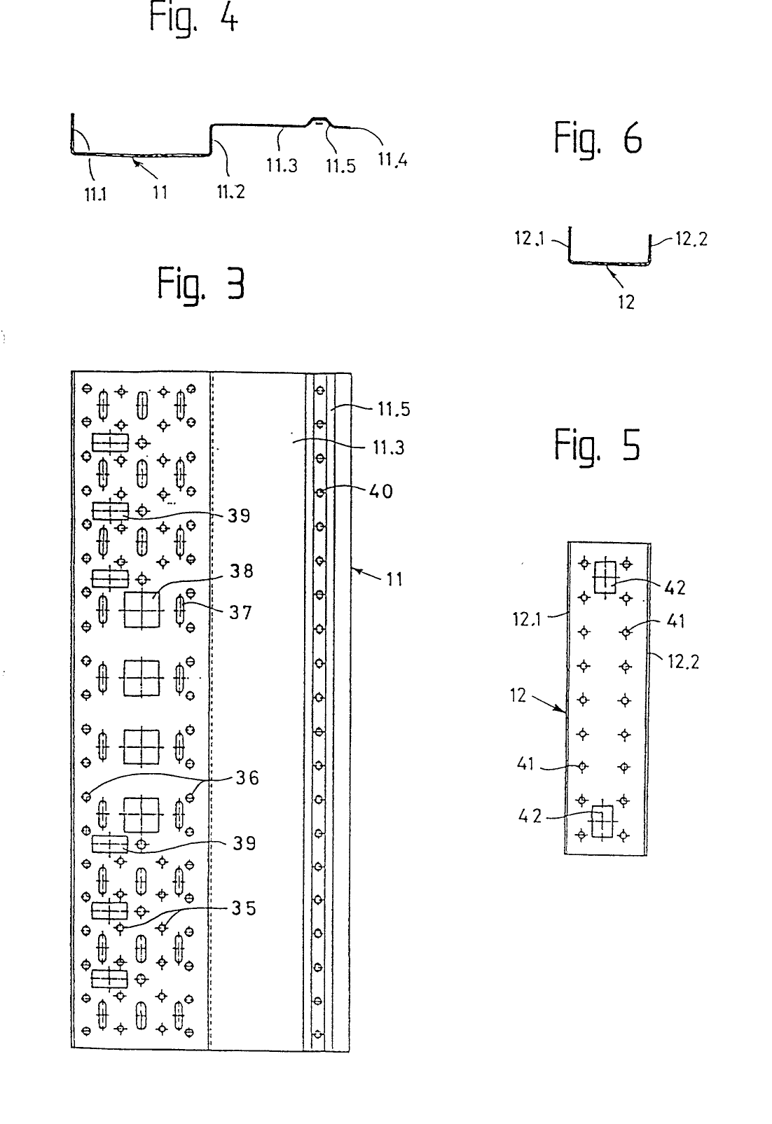

FIG. 3 shows an elevation of a base part of the carrier;

FIG. 4 shows a cross-section of the base part according to FIG. 3;

FIG. 5 shows an elevation of a length adapter of the carrier; and

FIG. 6 shows a cross-section of the length adapter according to FIG. 5.

A cage roof is designated by 2 and the front side of a lift cage 1 by 3 in FIGS. 1 and 2. Two C-section profile rails 4 and 5, to which two support brackets 6 and 7 are fastened, are arranged on the cage roof 2. The support brackets 6 and 7 are screw-connected with the C-section profile rails 4 and 5 by means of rotationally fast screws 8, which are guided in the C-section profile rails, and nuts 9. A carrier 10, which consists of a base part 11 and a length adapter 12 and is more closely described in the following by reference to FIGS. 3 to 6, is fastened to the support brackets 6 and 7. The carrier 10 is screw-connected with the support brackets 6 and 7 merely by way of the base part 11, whereas the length adapter 12 is connected with the base part 11. The most important components of a door drive, by means of which a door, consisting of two door leaves 13 and 14, of the lift cage 1 can be opened and closed, are arranged at the carrier 10. In FIGS. 1 and 2 these components fastened to the carrier 10 are illustrated merely by dotted lines and are briefly described in the following.

An electric motor 15 is screw-connected with the base part 11 of the carrier 10 by way of a motor bracket 16 and drives a belt pulley 18 by way of a belt 17. The belt pulley 18 is rotatably mounted by means of ball bearings 19.1 on a pin 19 fastened to the base part 11 and connected rotationally fast with a toothed belt pulley 20. A further toothed belt pulley 21 is rotatably mounted on the length adapter 12, which is screw-connected with the base part 11, and stands under the effect of a tensioning device, which is not illustrated, so that a toothed belt 22 guided over the toothed belt pulleys 20 and 21 always has a sufficient tension. Guide rails, which are screw-connected with the base part 11 by way of screws 25 and spacers 26, are designated by 23 and 24. Support rollers 29 are guided on the guide rails 23 and 24 and are rotatably arranged at guide carriages 27 and 28 by way of ball bearings 29.1, wherein the guide carriages 27 and 28 are firmly connected with the door leaves 13 and 14 by way of screw bolts 30.

Door drives of the kind briefly described in the foregoing are known. Reference is therefore made to, for example, EP-A 0 332 841 and EP-B 0 513 509 for further not-illustrated details such as, for example, the movement transmission from the toothed belt 22 to the guide carriages 27 or 28 or the entraining equipment for cage door and shaft door.

According to FIGS. 3 and 4 the base part 11, which consists of, for example, sheet steel, of the carrier 10 has a substantially U-shaped cross-section. In order to better protect the belt drive unit, the one U limb 11.1 of the base part 11 is longer than the other U limb 11.2. A prolongation 11.3, which is bent over at right angles and rests on the front side 3 of the lift cage 1 (FIG. 2), is provided at the other U limb 11.2. Two rows of first bores 35 and two rows of second bores 36 are provided in the base part 11. Moreover, the base part 11 similarly has elongate holes 37, square passages 38 and rectangular passages 39 arranged in rows. A shaped-out portion 11.5 of trapezium-shaped cross-section is provided in the region of a lower longitudinal edge 11.4 of the prolongation 11.3. The trapezium-shaped shaped-out portion 11.5 has a row of threaded holes 40, which are, for example, reinforced by means of drawn-through elements and are intended for the fastening of the guide rails 23 and 24. The square passages 38 are provided for the axle of the electric motor 15 and a belt pulley arranged on the axle. The rectangular passages 39 serve as cutouts for an infrared incremental transmitter of the door drive control. The elongate holes 37 are intended for the fastening of the motor bracket 16 and a carrier plate for the door drive electronic unit. The bores 35 and 36, elongate holes 37, passages 38 and 39 and threaded holes 40 preferably have a predetermined constant spacing from one another. The most diverse variants of the arrangement of the most important components are possible by the multiplicity of the different holes or passages, so that an optimum adaptation to construction conditions can be achieved.

The length adapter made of, for example, sheet steel has, according to FIGS. 5 and 6, a U-shaped cross-section which is smaller than the U-shaped cross-section of the base part 11. In order to better protect the belt drive unit, the one U limb 12.1 of the length adapter 12 is longer than the other U limb 12.2, wherein the U limbs 12.1 and 12.2 of the length adapter 12 are approximately equal in length to the U limbs 11.1 and 11.2 of the base part 11. Two rows of further bores 41, which are congruent with the first bores 35 of the base part 11, are provided in the length adapter 12. The length adapter 12 is used with greater door widths, wherein it can be adjusted in steps corresponding to the predetermined hole spacings and can be screw-connected with the base part 11. Rectangular passages, which are necessary for the mounting of the above-mentioned belt tensioning device, are designated by 42.

1. Carrier for door drives of lifts, characterised in that the carrier (10) consists of a base part (11) and of a length adapter (12), which are connectible together in such a manner that carriers (10) of different lengths are producible.

2. Carrier according to claim 1, characterised in that the base part (11) has at least two rows of first bores (35), and two rows of further bores (41) are provided in the length adapter (12), wherein the first and further bores (35, 41) are congruent and have a predetermined constant spacing from one another.

3. Carrier according to claim 2, characterised in that the base part (11) has a substantially U-shaped cross-section, wherein the one U limb (11.1) is longer than the other U limb (11.2).

4. Carrier according to claim 3, characterised in that a prolongation (11.3), which is bent over at right angles, is provided at the other U limb (11.2) of the base part (11).

5. Carrier according to claim 4, characterised in that a substantially trapezium-shaped shaped-out portion (11.5), in which a row of threaded holes (40) is arranged, is provided in the region of a lower longitudinal edge (11.4) of the prolongation (11.3) of the base part (11).

6. Carrier according to claim 3, characterised in that the length adapter (12) has a U-shaped cross-section which is smaller than the U-shaped cross-section of the base part (11), wherein a part of the length adapter (12) lying within the U limbs (11.1, 11.2) of the base part (11) is connectible with this.

7. Carrier according to claim 6, characterised in that the one U limb (12.1) of the length adapter (12) is longer than the other U limb (12.2) and that the U limbs (12.1, 12.2) of the length adapter (12) are approximately equal in length to the U limbs (11.1, 11.2) of the base part (11).

8. Carrier according to claim 1, characterised in that elongate holes (37) arranged in rows are provided in the base part (11).

9. Carrier according to claim 1, characterised in that square and rectangular passages (38, 39) arranged in rows are provided in the base part (11).

10. Carrier according to claim 1, characterised in that rectangular passages (42) are provided in the length adapter (12).
